(19) United States
(12) Patent Application Publication
(10) Pub. No.: US 2009/0273306 A1
(43) Pub. Date: Nov. 5, 2009

(54) FAN SPEED CONTROL CIRCUIT

(75) Inventor: Nelson Warner, Northbridge, MA (US)

Correspondence Address: BARLOW, JOSEPHS & HOLMES, LTD., 101 DYER STREET, 5TH FLOOR, PROVIDENCE, RI, 02903, US

(73) Assignee: TAMARACK TECHNOLOGIES, INC., Buzzards Bay, MA (US)

(21) Appl. No.: 12/432,169

(22) Filed: Apr. 29, 2009

Related U.S. Application Data
(60) Provisional application No. 61/049,956, filed on May 2, 2008.

(51) Int. Cl. H02K 7/14

(52) U.S. Cl. 318/3

(57) ABSTRACT

The fan speed control circuit and system of the present invention includes a capacitor or internally triggered triac to enable current to flow across the terminals of an electrical switch for a fan motor when the switch is in the open and OFF position to permit continued operation of a fan so that the system complies with the ASHRAE 62.2 standard. The capacitor may be of a fixed value so that the speed of the fan motor is reduced to a fixed level when the switch is open and OFF. Alternatively, a potentiometer and internally triggered triac arrangement may be used to permit adjustment of the level to which the speed of the fan drops to when the switch is actuated to the open and OFF position. The present invention is a viable less expensive option to prior art microprocessor based fan speed control circuits.

### CROSS REFERENCE TO RELATED APPLICATION

This application is related to and claims priority from earlier filed provisional patent application Ser. No. 61/049,956, filed May 2, 2008, the entire contents thereof is incorporated herein by reference.

### BACKGROUND OF THE INVENTION

The invention relates generally to electrical circuits. The invention more specifically relates to electrical control circuits that have particular application in controlling the operation of devices with motors, such as fans.

It is well known in the construction, architectural and interior design industries that enclosed spaces within a building, either of the commercial and residential nature, are susceptible to poor air quality. This is primarily due to lack of good ventilation and air circulation within that space. For example, spaces that are not exposed to good air flow or are exposed to moisture or particulate matter, such as bathrooms, are particularly problematic. As a result, the air quality can become poor that can create unwanted odors, growth of mold, health hazards, and the like.

Today, the air inside most homes is more polluted and unhealthy than outside air at its worst. The way air exchange has been done in the past has been to open windows. However, in today's market it is very costly to leave a window open at times particularly when it's cold or hot outside as this will compete with the heating or air conditioning systems that are operating at the time. Therefore, simply opening a window for ventilation and air circulation is not a viable or desirable option.

A better solution is to operate a fan continuously at a low speed to achieve the desired low rate of air exchange thus keeping the air in the home or business fresh and healthy. This also maintains the integrity of the heating or air conditioning system operating at the time. To mandate use of this solution, government standards for building construction have been developed toward improving the indoor air quality for both the commercial and residential markets. Most notably, compliance with the ventilation standard, such as “ASHRAE 62.2”, is mandatory for new building construction, which requires a certain number of air changes per hour and certain air flow rates. For example, the amount of cubic feet per minute of whole house ventilation and number of changes per hour is dependent on the square footage of the house, number of bedrooms and other factors. In general, in view of this standard, there is a need for a system that can deliver the needed ventilation to comply with this ASHRAE 62.2 government standard or other similar air exchange standards.

There have been a number of efforts in the prior art to address the need to provide the required ventilation to comply with government air exchange requirements. For example, commonly owned U.S. Pat. No. 5,722,887, sold under the trade name AIRETRAK, provides for a ventilation control is microprocessor-based control. However, due to the use of a microprocessor, it can be expensive. Also, the AIRETRAK is limited to fans that draw a maximum of 2 amps of current. While the AIRETRAK provides for a high level of fan and ventilation control, there is a need for a less expensive option for such a control system while also accommodating fans that operate at higher amperages, such as 8 amps, as well as a wider range of different types and sizes of fans.

In view of the foregoing, there is a demand for a fan speed control system that can deliver continuous fan operation to comply with the ASHRAE 62.2 requirement. There is a demand for a fan speed control system that is less expensive than prior art systems. There is yet another need for a fan speed control system that is easy to install and operate compared to prior art control systems.

### SUMMARY OF THE INVENTION

The present invention preserves the advantages of prior art fan speed control system systems. In addition, it provides new advantages not found in currently available systems and overcomes many disadvantages of such currently available systems.

The fan speed control circuit and system of the present invention is very unique in that it is less expensive than prior art systems yet still complies with the ASHRAE 62.2 standard and is easy to install and operate. The fan speed control system of the present invention works with a wide array of fan types and sizes. In contrast to known fan speed controls that are on the market today, which work well only with a very small fan group of “low current, condenser type motors”, the new fan speed control system of the present invention works well with high or low current inductive fans.

The passive fan speed control circuit of the invention includes an electrical switch. The electrical switch is actuatable between a closed ON position and a open OFF position. The first terminal of a capacitor is electrically connected to the first terminal of the electrical switch and the second terminal of the capacitor is electrically connected to the second terminal of the electrical switch. A first terminal of the fan motor is connected to the first terminal of the electrical switch and the second terminal of the fan motor connected to the second terminal of the electrical switch. A source of electricity connected across the first terminal and the second terminal of the electrical switch. Electricity flows across the first terminal and the second terminal of the electrical switch at full capacity to power the fan motor at full speed when the electrical switch is in the closed ON position and electricity flows across the first terminal and the second terminal of the electrical switch via the capacitor at less than full capacity to power the fan motor at less than full speed when the electrical switch is in the open OFF position.

The active embodiment of the fan speed control circuit of the invention includes an electrical switch that is actuatable between a closed ON position and a open OFF position. The first terminal of a first capacitor is electrically connected to the first terminal of the electrical switch. The first terminal of an internally triggered triac is connected to the first terminal of the first capacitor and the first terminal of the electric switch. The gate of the internally triggered triac is connected to the second terminal of the first capacitor. The first terminal of a potentiometer is connected to the second terminal of the first capacitor and the second terminal of the potentiometer is connected to the second terminal of the electrical switch. The second terminal of the internally triggered triac is connected to the second terminal of the potentiometer and the second terminal of the electrical switch. The first terminal of a fan motor is connected to the first terminal of the electrical switch and the second terminal of the fan motor connected to the second terminal of the electrical switch; A source of electricity connected across the first terminal and the second terminal of the electrical switch.

When electricity flows across the first terminal and the second terminal of the electrical switch at full capacity, the fan motor is powered at full speed when the electrical switch is in the closed ON position and when electricity flows across the first terminal and the second terminal of the electrical switch via the first capacitor and internally triggered triac at a less than full capacity, the fan motor is powered at less than full speed when the electrical switch is in the open OFF position; the less than full capacity and less than full speed is controlled by the potentiometer.

It is therefore an object of the present invention to provide an expensive fan speed control circuit and system.

An object of the invention is to provide a fan speed control circuit that does not use microprocessors or timers;

A further object of the present invention is to provide a fan speed control circuit and system that can deliver continuous fan operation to comply with the ASHRAE 62.2 requirement.

Yet another object of the present invention is to provide a fan speed control circuit that is easy to install and operate.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a circuit diagram of the fan control circuit of a first embodiment of the present invention;

FIG. 2 is a side elevational view of the fan control circuit installed into a standard electric switch;

FIG. 3 is a circuit diagram of the fan control circuit of a second embodiment of the present invention;

FIG. 4 is a perspective view of a circuit board employing the circuit of FIG. 3;

FIG. 5 is a circuit diagram of the fan control circuit of a third embodiment of the present invention;

FIG. 6 is a perspective view of a circuit board employing the circuit of FIG. 5;

FIG. 7 is a circuit diagram of the fan control circuit of a fourth embodiment of the present invention; and

FIG. 8 is a perspective view of a circuit board employing the circuit of FIG. 7;

### DETAILED DESCRIPTION OF THE PREFERRED EMBODIMENT

The fan speed control circuit allows any location to be equipped with a fan speed control. For example, a business or home owner can easily control the speed control of motor, such as a c-frame motor that may be used in a fan environment, with the fan speed control circuit of the present invention. This can't be achieved by prior art controls, such as the AIRETRAK mentioned above, because of triac circuit base. This is because the triac circuit base typically undesirably shortens the life of a c-frame fan motor by 70% or more, which is unacceptable. This is also true if a speed control is used on any fan that cannot manage the added heat gain in the motor coil caused by the triac based circuit.

Still further, prior art speed controls, on the market today, undesirably add hum and heat to the fan motor. In contrast, the fan speed control circuit of the present invention does not add heat or coil noise to the fan motor.

Therefore, the fan speed control circuit of the present invention provides a cost-effective solution for a builder, home owner or business to exchange the indoor air using a new or existing bathroom fan to meet the ASHRAE 62.2 or other standards. The fan speed control system enables the business or homeowner a way to improve their indoor air quality by allowing them to continuously run their room fan, such as a bathroom fan, at a low speed. The fan speed control system has unique features in that it can be simply installed and “adjusted for airflow” in most any home or business without complicated rewiring. Another unique feature is that the control can be overridden by an existing wall switch, by simply turning the switch on, thereby allowing the fan to be brought to full speed.

Also, the fan speed control circuit is an analog control that has no clock or timer functions. Such an analog design accomplishes this by avoiding expensive microprocessors and simplifying installation to fit into a very broad market. In accordance with the present invention, it is envisioned that a number of different versions of the fan speed control be provided so that a wide array of fan models can be accommodated, such as many models made by AirKing, Panasonic and Soler & Palau and other manufacturers. This is a vast improvement over prior art fan speed controls that can control only a few fan models.

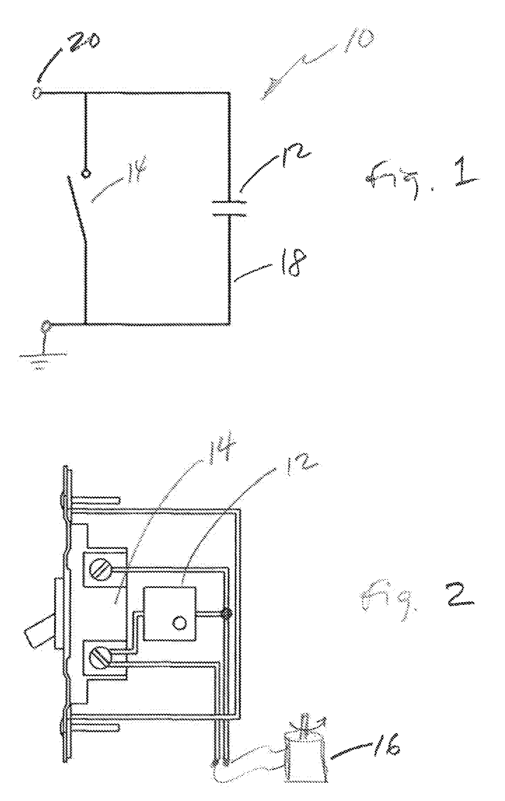

The fan speed control circuit of the present invention can be provided in many different configurations to enable different control features and characteristics. FIGS. 1-8 set forth four different embodiments of the present invention. It should be understood that these are representative embodiments and the scope and coverage of the present invention is not intended to be limited in any way to these embodiments.

Turning first to FIGS. 1 and 2, a first and preferred embodiment 10 of the fan control circuit of the present invention is shown in detail. This embodiment 10 is directed to a simple passive version of a “universal fan control” of the instant invention. This first embodiment 10 includes a passive circuit design that provides a capacitor 12 in parallel with the switch 14 that is connected to the fan motor 16 itself. The capacitor 12 is selected and tuned so that when the switch 14 is in the open or OFF position, some current will still continue to flow through the capacitor leg 18 of the circuit when power is applied across the switch at 20. The type and/or size of the capacitor 12 can be modified to alter the flow of electricity therethrough to, in turn, control the speed of a fan (not shown) connected to a fan motor 16 connected to a power supply 20 via the circuit of the present invention. For example, the capacitor 12 may be 1.5 μf/4.7 μf at 250 V to permit approximately 0.5 to 0.75, with a maximum of 3.0, amps of current to flow therethrough. This controlled continued current flow allows for enough current to power a motor 16 at partial speed to, in turn, power a fan connected thereto to provide the continuous airflow discussed above. In this example, a decreased controlled current flow of 0.5 to 0.75 amps, for example, could equate approximately to powering a typical fan motor 16 at a percentage that is less than its full capacity when the electric switch for the motor 16 is in the OFF position. It should be understood that this less percentage depends on the type, manufacturer and efficiency of the motor 16.

It is envisioned that a line of switch products with pre-installed capacitors 12, perhaps color coded for clarity, are provided to deliver a pre-set desired amount of speed of a fan motor 16 when the switch 14 is in the open/OFF position. For example, one may provide 30% speed while another provides 20% speed when the electric switch 14 is in the OFF position.

The fan control circuit of the present invention also contemplates active circuit design embodiments 100, 200 and 300 where the heat and coil noise is reduced by over 75% in comparison to the prior art AIRETRAK and other speed controls that can be purchased today. The fan speed control circuits 10, 100, 200 and 300 of the present invention provides the user a way to control the speed of any high/low current condenser, inductance or c-frame fan motor 16. This cannot be achieved by prior art circuits and systems.

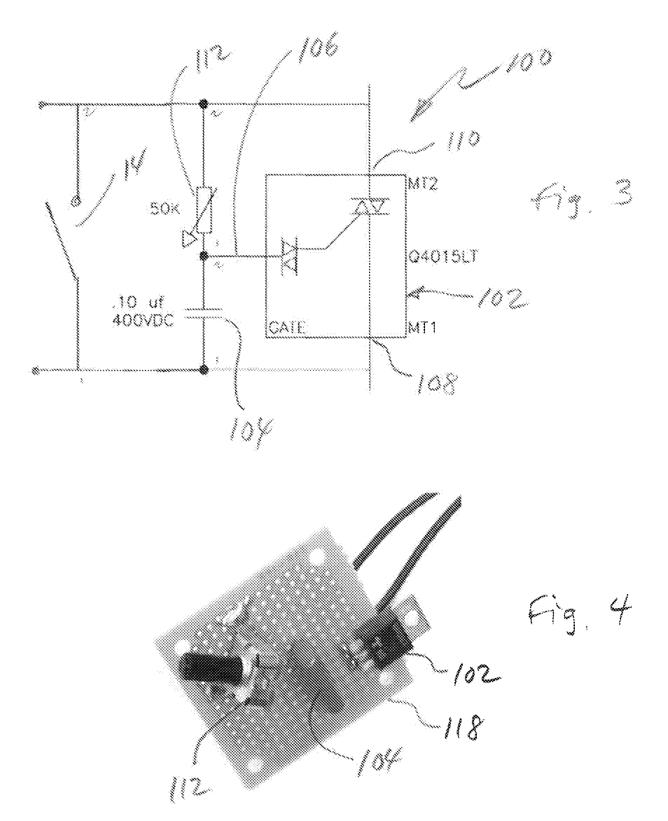

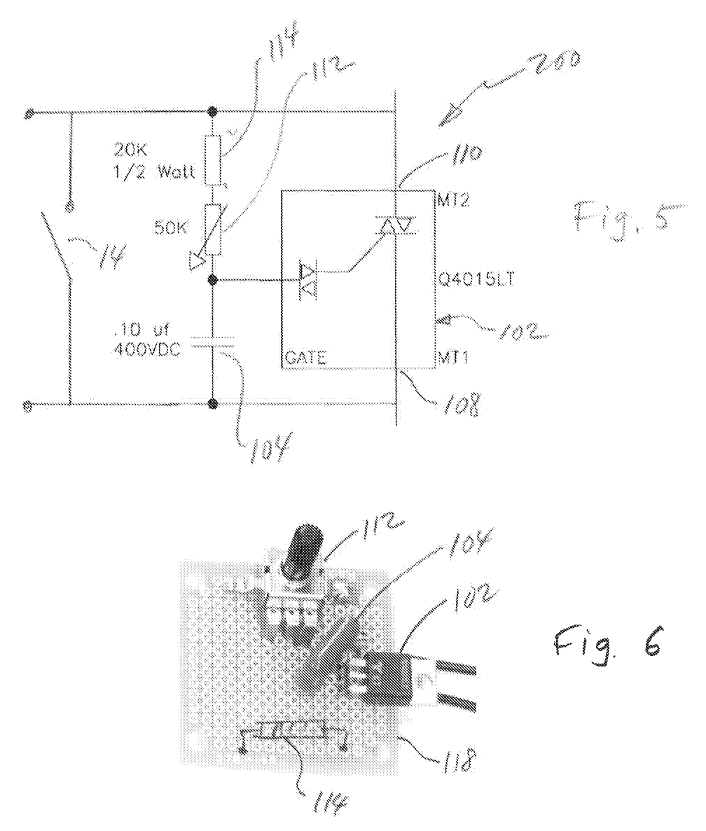

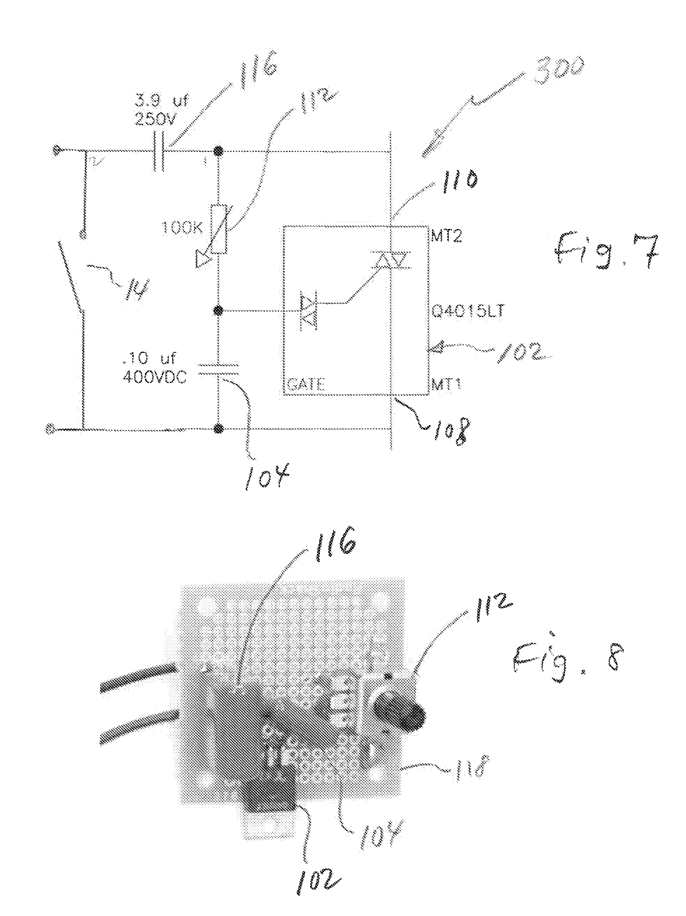

In addition to the preferred embodiment 10, the second 100, third 200 and fourth 300 alternative embodiments of the present invention provide for three different active circuit designs that also provide for some type of current flow even when the switch 14 is in an open or OFF position. The second embodiment 100 is seen in FIGS. 3 and 4. The third embodiment 200 is seen in FIGS. 5 and 6 while the fourth embodiment 300 of the present invention is shown in FIGS. 7 and 8.

In these active versions, the current flow when the switch 14 is OFF is adjustable in contrast to the fixed current flow found in the first embodiment shown in FIGS. 1 and 2. To accomplish this in these active versions, a Quadrac 102, such as Model Q4015LT sold by Teccor Electronics, is preferably used to stabilize the linear adjustability of the fan so that it exhibits less choppiness for smoother operation. Also, such a Quadrac 102 works better on a reduced voltage than a standard dimmer. A Quadrac is, essentially, an internally triggered triac where a diac trigger in mounted inside the same package. The operation of Quadracs (internally triggered triacs) 102 are so well known in the art that they need not be discussed in further detail herein. In these active versions that use a Quadrac 102, voltage variation will not damage the fan motor 16 and coil hum will be avoided. As a result, the life of the fan motor 16 is not compromised by use of the circuits 10, 100, 200 and 300 of the present invention. Each of these versions 10, 100, 200 and 300 may be more suitable for a given type or size of fan motor 16 therein.

Referring now to FIGS. 3 and 4, the second embodiment 100 of the invention includes a internally triggered triac (Quadrac) 102 with a capacitor 104 across the gate 106 and terminal MT1 108 and rheostat/potentiometer 112 across the gate 106 and terminal MT2 110. Thus, when the switch 14, across terminals MT1 108 and MT2 110 is open, current still continues to flow, the amount of which is controlled by the rheostat/potentiometer 112.

In FIGS. 5 and 6, a third embodiment 200 of the invention is shown which further adds a resistor 114 in series with the rheostat/potentiometer 112.

Still further, FIGS. 7 and 8 illustrate a fourth embodiment 300 of the invention that adds an additional capacitor 116 compared to the third embodiment 200 of FIGS. 5 and 6.

In general, the fan speed control circuits and systems 10, 100, 200 and 300 of the present invention can operate fan motors 16 that use up to 8 amps of current, which enables many more fan motor models to be accommodated by the present invention. The fan speed control systems 10, 100, 200 and 300 solve a large majority of the indoor air quality problems that business and home owners encounter today. As a result, the fan speed control can be used in conjunction with a fan to remove stale air from crawl spaces, garages, attics, and the like and to comply with the ASH RAE Standard 62.2.

The fan speed control circuits and systems 10, 100, 200 and 300 of the present invention may be constructed and configured in many different ways. As seen in FIG. 2 for the first embodiment 10 of the invention, the capacitor 12 can be a standalone capacitor that is individually packaged or encapsulated and provided with the necessary leads for interconnection to an electrical switch 14. The capacitor 12 may also be miniaturized on a single computer chip to facilitate installation or incorporation of the circuit 10 into an electrical switch 14 or surrounding components

In FIGS. 4, 6 and 8, the circuits 100, 200 and 300, respectively, can be provided in the form of a circuit board 118 with individual components populated thereon. Alternatively, the components may be miniaturized on a single computer chip to facilitate installation or incorporation of the circuits 10, 100, 200 and 300 into an electrical switch 14 or surrounding components.

It would be appreciated by those skilled in the art that various changes and modifications can be made to the illustrated embodiments without departing from the spirit of the present invention. All such modifications and changes are intended to be covered by the present invention.

What is claimed is:

1. A fan speed control circuit, comprising:
an electrical switch having a first terminal and a second terminal; the electrical switch being actuatable between a closed ON position and a open OFF position;
a capacitor having a first terminal and a second terminal; the first terminal of the capacitor being electrically connected to the first terminal of the electrical switch and the second terminal of the capacitor being electrically connected to the second terminal of the electrical switch;
a fan motor having a first terminal and a second terminal; the first terminal of the fan motor connected to the first terminal of the electrical switch and the second terminal of the fan motor connected to the second terminal of the electrical switch;
a source of electricity connected across the first terminal and the second terminal of the electrical switch; and
whereby electricity flows across the first terminal and the second terminal of the electrical switch at full capacity to power the fan motor at full speed when the electrical switch is in the closed ON position and electricity flows across the first terminal and the second terminal of the electrical switch via the capacitor at less than full capacity to power the fan motor at less than full speed when the electrical switch is in the open OFF position.
